(19) United States
(12) Patent Application Publication
(10) Pub. No.: US 2022/0128315 A1
(43) Pub. Date: Apr. 28, 2022

(54) STRUCTURE, AND METHOD FOR MANUFACTURING SAME

(71) Applicant: YAZAKI ENERGY SYSTEM CORPORATION, Tokyo (JP)

(72) Inventor: Takuju Nakamura, Hamamatsu-shi (JP)

(21) Appl. No.: 17/571,436

(22) Filed: Jan. 7, 2022

Related U.S. Application Data
(63) Continuation of application No. PCT/JP2020/028557, filed on Jul. 22, 2020.

(30) Foreign Application Priority Data
Aug. 9, 2019 (JP) 2019-147749

(51) Int. Cl. F28D 15/04; B23P 15/26

(52) U.S. Cl. CPC F28D 15/04; B23P 2700/09; B23P 15/26

(57) ABSTRACT

A structure includes: a heat insulating layer; an evaporator provided on one surface side of the heat insulating layer; a condenser provided on the other surface side of the heat insulating layer; a vapor flow path for guiding refrigerant vapor generated as a result of evaporation at the evaporator to the condenser; and a liquid refrigerant flow path for guiding a liquid refrigerant generated as a result of condensation at the condenser to the evaporator, in which the evaporator has a wick layer for evaporating the refrigerant stored on a lower portion side with heat from one surface side of the evaporator while suctioning up the refrigerant by capillarity and holding the refrigerant, and the evaporator and the condenser are installed so as to overlap by ½ or more in the direction in which the wick layer suctions up the refrigerant.

### CROSS REFERENCE TO RELATED APPLICATIONS

This application is a continuation of PCT application No. PCT/JP2020/028557, which was filed on Jul. 22, 2020 based on Japanese patent application 2019-147749 filed on Aug. 9, 2019, whose contents are incorporated herein by reference. Also, all the references cited herein are incorporated as a whole.

### BACKGROUND OF THE INVENTION

### Technical Field

The present invention relates to a structure and a method for manufacturing the same.

### Background Art

In the related art, a wall structure for heat dissipation has been proposed in which substantially N-shaped heat pipes are provided in multiple stages above and below a heat insulating material (see Patent Literature 1). In this wall structure for heat dissipation, the substantially N-shaped heat pipe is a hollow body in which a refrigerant is stored. The heat pipe includes a heat dissipation portion having a wick, a connecting portion, and a condensation portion. After evaporation in the heat dissipation portion, the refrigerant passes through the connecting portion and condenses on the condensation portion side. As a result, the wall structure for heat dissipation is capable of transferring heat from one surface side having the heat dissipation portion to the other surface side having the condensation portion.

### CITATION LIST

### Patent Literature

[Patent Literature 1] JP-A-H06-129787

### SUMMARY

Here, the wall structure for heat dissipation described in Patent Literature 1 is provided with the wick in order to solve the problem that the heat pipes need to be provided in multiple stages and the height direction with respect to one wall. By this wick being provided, the area of evaporation is expanded in the height direction and the number of heat pipe stages is reduced.

However, in the wall structure for heat dissipation described in Patent Literature 1, the condensation portion of each heat pipe is installed higher than the evaporation portion, and thus dead spaces arise in the uppermost portion on the heat dissipation portion side (one surface side) and the lowermost portion on the condensation portion side (the other surface side) of the surface where the heat pipe is installed and the space corresponding to one heat pipe stage in total is wasted. In particular, the wall structure for heat dissipation described in Patent Literature 1 tends to cause dead space expansion because the wick is provided and the heat dissipation portion is expanded in the height direction.

An embodiment of the present invention, a structure and a method for manufacturing the structure can achieve a decrease in the number of stages and a decrease in dead space.

A structure according to the present invention includes: a heat insulating layer; an evaporator formed using a space portion between a plurality of plate materials provided on one surface side of the heat insulating layer; a condenser formed using a space portion between a plurality of other plate materials provided on the other surface side of the heat insulating layer; a vapor flow path for guiding refrigerant vapor generated as a result of evaporation at the evaporator to the condenser; and a liquid refrigerant flow path for guiding a liquid refrigerant generated as a result of condensation at the condenser to the evaporator, in which the evaporator has a wick layer for evaporating the refrigerant stored on a lower portion side with heat from one surface side of the evaporator while suctioning up the refrigerant by capillarity and holding the refrigerant, and the evaporator and the condenser are installed so as to overlap by ½ or more in the direction in which the wick layer suctions up the refrigerant.

As for this structure, the evaporator has the wick layer for evaporating the refrigerant stored on the lower portion side with the heat from the one surface side of the evaporator while suctioning up the refrigerant by capillarity and holding the refrigerant. Accordingly, the wick layer is capable of extending the evaporation part in the suction direction, a larger area can be covered with a smaller number of stages, and a contribution can be made to reducing the number of stages.

In addition, in a case where the wick layer vertically suctions up the refrigerant, the evaporator and the condenser are installed so as to overlap by ½ or more in the vertical direction. Accordingly, the amount of suction-direction misalignment between the evaporator and the condenser decreases and a dead space is unlikely to arise. Accordingly, a decrease in the number of stages and a decrease in dead space can be achieved.

A structure manufacturing method according to the present invention includes: a joining step of partially joining four or more plate materials; a space forming step of forming a wick powder introduction space by performing pressurization in a high-temperature environment of 800° C. or higher between the four or more plate materials partially joined in the joining step; a powder introduction step of introducing wick layer forming powder into the introduction space formed in the space forming step; and a solidification step of solidifying the powder introduced in the powder introduction step in a state where the high-temperature environment is maintained.

According to this structure manufacturing method, the wick powder introduction space is formed by performing the inter-plate material pressurization in the high-temperature environment of 800° C. or higher, the wick layer forming powder is introduced into the formed introduction space, and the introduced powder is solidified with the high-temperature environment maintained. Accordingly, the powder can be solidified and a wick layer can be formed without any change in the high-temperature environment in which the plate material is processed and a contribution can be made to the smooth manufacturing of the structure.

### BRIEF DESCRIPTION OF THE DRAWINGS

FIG. 1 is a first schematic cross-sectional view illustrating a structure according to an embodiment of the present invention, in which a cross section cut along a height direction is illustrated.

FIG. 2 is a second schematic cross-sectional view illustrating the structure according to the embodiment of the present invention, in which a cross section cut along a horizontal direction is illustrated.

FIGS. 3A to 3D are process diagrams illustrating a structure manufacturing method according to the present embodiment, in which a first step, a second step, a third step, and a diffusion-joined body are illustrated in FIGS. 3A to 3D, respectively.

FIGS. 4A to 4C are process diagrams illustrating the structure manufacturing method according to the present embodiment, in which fourth to sixth steps are illustrated in FIGS. 4A to 4C, respectively.

FIGS. 5A to 5D are process diagrams illustrating the structure manufacturing method according to the present embodiment, in which seventh to tenth steps are illustrated in FIGS. 5A to 5D, respectively.

FIGS. 6A and 6B are process diagrams illustrating the structure manufacturing method according to the present embodiment, in which eleventh and twelfth steps are illustrated in FIGS. 6A and 6B, respectively.

FIG. 7 is a schematic configuration diagram illustrating the lower portion side of a structure according to a second embodiment.

### DETAILED DESCRIPTION OF EMBODIMENTS

Hereinafter, the present invention will be described with reference to preferred embodiments. It should be noted that the present invention is not limited to the following embodiments and can be appropriately modified without departing from the spirit of the present invention.

Although the illustration and description of some configurations are omitted in the following embodiments, it is a matter of course that publicly known or well-known techniques not contradictory to the content described below are appropriately applied as to details of the omitted techniques.

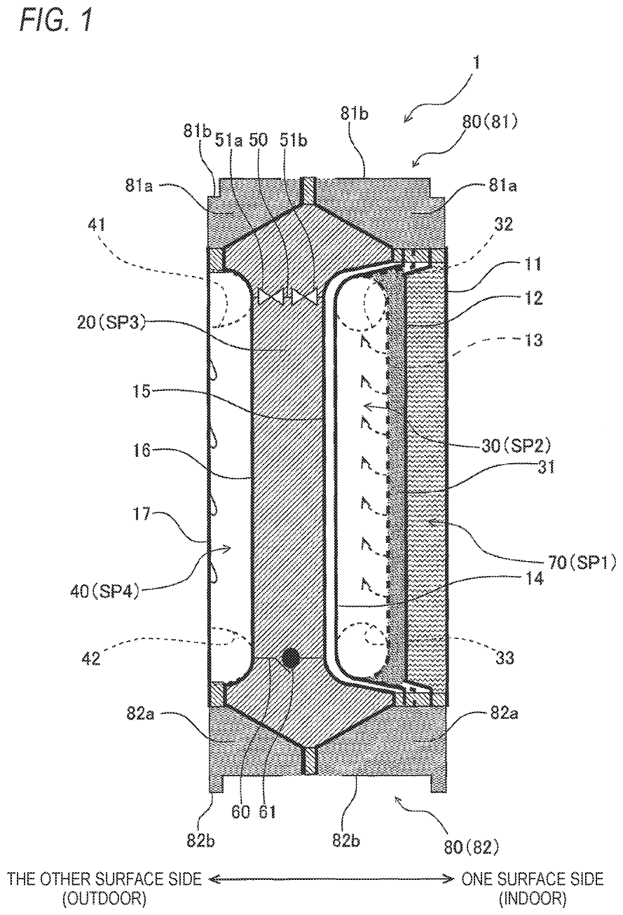

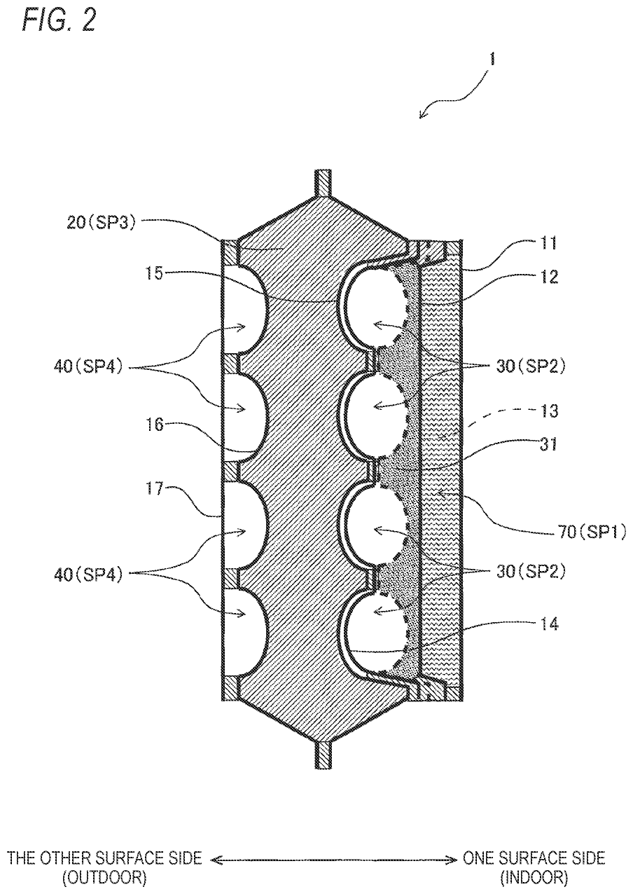

FIG. 1 is a first schematic cross-sectional view illustrating a structure according to an embodiment of the present invention, in which a cross section cut along a height direction is illustrated. FIG. 2 is a second schematic cross-sectional view illustrating the structure according to the embodiment of the present invention, in which a cross section cut along a horizontal direction is illustrated.

A structure 1 illustrated in FIGS. 1 and 2 is used as, for example, a vertically extending wall material (wall material for indoor-outdoor separation). The structure 1 includes seven (a plurality of) plate materials 11 to 17, a heat insulating layer 20, an evaporator 30, a condenser 40, a vapor flow path 50, a liquid refrigerant flow path 60, a latent heat storage material 70, and a vertical stacking member 80.

The seven plate materials 11 to 17 are metallic plate materials such as stainless steel and titanium plate materials. Of the plate materials 11 to 17, the third plate material 13, which is the third from the indoor side (one surface side), is configured by a plate material having an opening portion such as a punch mesh.

First to fourth space portions SP1 to SP4 are formed between the first plate material 11 and the second plate material 12, between the second plate material 12 and the fourth plate material 14, between the fifth plate material 15 and the sixth plate material 16, and between the sixth plate material 16 and the seventh plate material 17, respectively.

The heat insulating layer 20 exhibits heat insulation performance between the one surface side and the other surface side. Solidified pearlite powder or the like is used as the heat insulating layer 20 in the present embodiment. The heat insulating layer 20 is stored in the third space portion SP3 between the fifth plate material 15 and the sixth plate material 16.

Further, the third space portion SP3 is in a vacuum state. Accordingly, the structure 1 according to the present embodiment has a vacuum heat insulating portion.

The evaporator 30 is provided on the one surface side of the heat insulating layer 20 and is formed using the second space portion SP2 between the second plate material 12 and the fourth plate material 14 (plurality of plate materials). The second space portion SP2 is in, for example, a vacuum state. The evaporator 30 functions as an evaporator evaporating a liquid refrigerant (for example, water) with heat from the one surface side. Further, the evaporator 30 includes a wick layer 31 between the second plate material 12 and the third plate material 13. The wick layer 31 suctions up the refrigerant stored on the lower portion side of the evaporator 30 via the third plate material 13 by capillarity and holds the refrigerant. With the wick layer 31, the evaporation area of the evaporator 30 expands along the height direction and high-efficiency evaporation is possible in the height direction.

It should be noted that the evaporator 30 is divided into a plurality of (four) rooms as illustrated in FIG. 2. Each room extends in the height direction, is provided with a header member 32 and a footer member 33 in the uppermost portion and the lowermost portion, and is connected to other rooms via the header member 32 and the footer member 33.

The condenser 40 is provided on the other surface side of the heat insulating layer 20 and is formed using the fourth space portion SP4 between the sixth plate material 16 and the seventh plate material 17 (plurality of other plate materials). The fourth space portion SP4 is also in, for example, a vacuum state. The condenser 40 functions as a condenser condensing the refrigerant with heat from the other surface side (for example, outside air temperature). The condensed liquid refrigerant is stored in the lowermost portion of the condenser 40.

In addition, the condenser 40 is also divided into a plurality of (four) rooms as illustrated in FIG. 2. Each room extends in the height direction, is provided with a header member 41 and a footer member 42 in the uppermost portion and the lowermost portion, and is connected to other rooms via the header member 41 and the footer member 42.

The vapor flow path 50 is a flow path for guiding the refrigerant vapor generated as a result of the evaporation at the evaporator 30 to the condenser 40. The vapor flow path 50 interconnects the header member 32 of the evaporator 30 and the header member 41 of the condenser 40.

In addition, the vapor flow path 50 includes two temperature-sensitive valves 51a and 51b. The temperature-sensitive valve Ma is open when the temperature on the one surface side of the structure 1 (for example, temperature of the latent heat storage material 70 (or room temperature)) is equal to or higher than a predetermined temperature (for example, temperature appropriately set in the range of 24° C. or higher and 30° C. or lower) and is closed when the temperature is lower than the predetermined temperature. In addition, the temperature-sensitive valve 51b is closed when the temperature on the other surface side of the structure 1 (for example, outdoor atmospheric temperature) is equal to or higher than a predetermined temperature (for example, temperature appropriately set in the range of 24° C. or higher and 30° C. or lower) and is open when the temperature is lower than the predetermined temperature. It should be noted that the vapor flow path 50 may be formed inside the plurality of plate materials 11 to 17 or may be formed with a pipe attached outside.

The liquid refrigerant flow path 60 is a flow path for guiding the liquid refrigerant generated as a result of the condensation at the condenser 40 to the evaporator 30. The liquid refrigerant flow path 60 interconnects the footer member 33 of the evaporator 30 and the footer member 42 of the condenser 40.

In addition, the liquid refrigerant flow path 60 includes a check valve 61. The check valve 61 is a valve for automatically preventing backflow. For example, the check valve 61 prevents the refrigerant from flowing in the direction from the evaporator 30 to the condenser 40 and allows the refrigerant to flow in the direction from the condenser 40 to the evaporator 30. It should be noted that the liquid refrigerant flow path 60 may be formed inside the plurality of plate materials 11 to 17 or may be formed with a pipe attached outside as in the case of the vapor flow path 50.

The latent heat storage material 70 has a phase change temperature (melting and freezing points) in a specific temperature range (for example, 24° C. or higher and 30° C. or lower). The latent heat storage material 70 is formed using the first space portion SP1 between the first plate material 11 and the second plate material 12. The latent heat storage material 70 is disposed closest to the one surface side of the structure 1, and thus the latent heat storage material 70 functions to keep a specific indoor temperature range. In addition, by including the latent heat storage material 70, the structure 1 is capable of, for example, performing indoor cooling with the latent heat storage material 70 by day in summer and dissipating the heat of the latent heat storage material 70 to the other surface side when the outdoor temperature drops at night as will be described later.

The vertical stacking member 80 is provided at the upper and lower ends of the structure 1. The vertical stacking member 80 includes an upper end member 81 and a lower end member 82.

The upper end member 81 is put on the seven plate materials 11 to 17. The upper end member 81 includes a hard heat insulating material 81a such as a calcium silicate board and a stainless steel plate 81b as the outer skin of the hard heat insulating material 81a. The upper end member 81 as a whole has a projecting structure having a protruding middle portion with both end portions chipped in part. In the upper end member 81, the stainless steel plate 81b is separated on the one surface side and the other surface side and prevents heat transfer through the stainless steel plate 81b.

The lower end member 82 is put beneath the seven plate materials 11 to 17. The lower end member 82 includes a hard heat insulating material 82a such as a calcium silicate board and a stainless steel plate 82b as the outer skin of the hard heat insulating material 82a. The lower end member 82 as a whole has a recessed structure having a recessed middle portion. The projecting structure of the upper end member 81 fits into the recessed structure of the lower end member 82. Accordingly, a plurality of the structures 1 can be vertically stacked. Also in the lower end member 82, the stainless steel plate 82b is separated on the one surface side and the other surface side and prevents heat transfer through the stainless steel plate 82b.

Further, as illustrated in FIG. 1 in the present embodiment, the evaporator 30 and the condenser 40 overlap by ½ or more (completely overlap in FIG. 1) in the direction in which the wick layer 31 suctions up the liquid refrigerant (height direction in the present embodiment (vertical direction in particular)). It should be noted that the evaporator 30 and the condenser 40 preferably overlap by ⅔ or more and more preferably overlap by ¾ or more in the suction direction. It should be noted that the overlap of ½ or more referred to here means that the value obtained by dividing the sum of the part of the suction-direction length of the evaporator 30 that overlaps the condenser 40 in the suction direction and the part of the suction-direction length of the condenser 40 that overlaps the evaporator 30 in the suction direction by the sum of the suction-direction lengths of the entire evaporator 30 and the entire condenser 40 is ½ or more. The same applies to the overlap of ⅔ or more and the like.

As described above, in the structure 1 according to the present embodiment, the evaporator 30 and the condenser 40 overlap by at least ½ in the suction direction. Accordingly, dead space suppression can be achieved as compared with a case where the positions of both are misaligned by more than ½ in the suction direction.

In addition, the wick layer 31 is formed by solidifying powder non-uniform in particle size in a particle size range of 150 micrometers or less (for example, pearlite powder). Specifically, powder with a particle size of 80 micrometers or more and 150 micrometers or less is approximately ⅓ (¼ or more and ½ or less), powder with a particle size of 50 micrometers or more and less than 80 micrometers is approximately ⅓, and powder with a particle size of less than 50 micrometers is approximately ⅓.

Here, the present inventor has found that the suction effect is enhanced as compared with the case of a uniform particle size by making the particle size of the wick layer 31 sparse as described above. As a result, the structure 1 according to the present embodiment is capable of suctioning up the liquid refrigerant up to a height of 2 m, more preferably, approximately 0.2 m or more and 1.0 m or less and holding the liquid refrigerant.

In addition, the wick layer 31 according to the present embodiment preferably has a heat resistance of 850° C. or higher. Here, the structure 1 highly resistant to heat as a whole can be obtained by using a material having a heat resistance of 850° C. or higher and used as, for example, a building material for the other parts of the structure 1 (for example, the plate materials 11 to 17 and the heat insulating layer 20 with the exception of the latent heat storage material 70).

Further, in the structure 1 according to the present embodiment, the outer surfaces of the first plate material 11 and the seventh plate material 17 are enameled at least in part. With this enamel, the structure 1 is capable of having a reflectance of 80% or more for infrared rays and visible light and an absorption rate (emissivity) of 80% or more for far infrared rays. Such characteristics are particularly suitable for outdoor and indoor surfaces in the case of use for heat dissipation and an indoor surface in the case of use for heat collection. In the case of use for heat collection, a film for selective sunlight absorption or the like having a high infrared absorption rate and a low far infrared absorption rate (emissivity) may be used on an outdoor surface.

Next, the operation of the structure 1 according to the present embodiment in a case where the structure 1 is used as a wall material for indoor-outdoor separation for the purpose of indoor-to-outdoor heat dissipation in summer will be described.

First, in a case where the room temperature is higher than a specific temperature range by day in summer, indoor cooling is performed by the latent heat storage material 70 provided in the first space portion SP1. During the cooling, the inside of the evaporator 30 is saturated with refrigerant vapor in equilibrium with the liquid refrigerant accumulated in the lower portion thereof and the temperature-sensitive valve 51a is released. In the present embodiment, the condenser 40 is installed at the same height as the evaporator 30, and thus the liquid refrigerant is accumulated in the lower portion of the condenser 40 as well and the condenser 40 is also saturated with the refrigerant vapor in equilibrium with the liquid refrigerant. While the outdoor temperature is higher than the indoor temperature, the refrigerant vapor in the condenser 40 is higher in pressure than the refrigerant vapor in the evaporator 30, and yet the refrigerant vapor does not flow back from the condenser 40 to the evaporator 30 since the temperature-sensitive valve 51b is closed. As an example, in a case where the refrigerant is water, the temperature of the condenser 40 (outdoor surface temperature) is 40° C., and the temperature of the evaporator 30 (indoor surface temperature) is 28° C., the difference in saturated water vapor pressure corresponds to the water column pressure of 355 mm. Accordingly, in a case where the evaporator 30 and the condenser 40 are installed in a lower end height-aligned manner, it is necessary to ensure a height of 355 mm or more for the refrigerant pool in the evaporator 30 in this temperature state by adjusting the amount of the refrigerant to be sealed and prevent the vapor refrigerant from blowing from the condenser 40 to the evaporator 30 through the liquid refrigerant flow path 60. As a matter of course, the total height of the evaporator 30 needs to be higher.

When the outside air temperature subsequently becomes lower than the specific temperature range at night in summer, the refrigerant vapor pressure in the condenser 40 drops below the refrigerant vapor pressure in the evaporator 30, the temperature-sensitive valve 51b is released, and the refrigerant vapor in the evaporator 30 reaches the condenser 40 via the vapor flow path 50. The vapor refrigerant that has reached the condenser 40 is condensed into a liquid refrigerant. The heat of condensation is dissipated outdoors via the seventh plate material 17. In the evaporator 30, where a decline in pressure has occurred as a result of the outflow of the refrigerant vapor, the liquid refrigerant in the evaporator 30 suctioned up by the wick layer 31 evaporates. At this time, the heat of vaporization is taken from the latent heat storage material 70. As a result, even in a case where the room temperature is high in summer, the heat can be dissipated outdoors. Even in a case where the outdoor temperature is higher than the indoor temperature by day in summer, in particular, the heat can be dissipated outdoors by the latent heat storage material 70 functioning as a buffer.

In winter, it is undesirable to dissipate the indoor heat outdoors. In such a case, the temperature-sensitive valve 51a is closed, and then the circulation of the refrigerant can be stopped and the indoor heat can be prevented from escaping outdoors. As an example, in a case where the refrigerant is water, the temperature of the condenser 40 (outdoor surface temperature) is 0° C., and the temperature of the evaporator 30 (indoor surface temperature) is 20° C., the evaporator 30 is higher in pressure, there is a difference corresponding to the water column pressure of 230 mm, and yet the check valve 61 is capable of preventing the liquid refrigerant from flowing back from the evaporator 30 to the condenser 40 through the liquid refrigerant flow path 60.

The structure 1 according to the present embodiment can be used as a wall material for indoor-outdoor separation for the purpose of outdoor-to-indoor heat collection in winter. In this case, surface treatment such as enameling and a selective absorption film is appropriately changed, the wall is turned inside out, and the evaporator 30 is installed on the outdoor side and the condenser 40 is installed on the indoor side. As an example of when it is undesirable to take outdoor heat indoors in summer, in a case where the refrigerant is water, the condenser temperature (indoor surface temperature) is 28° C., and the temperature of the evaporator exposed to direct sunlight or the like (outdoor surface temperature) is 50° C., the saturated water vapor pressure in the evaporator 30 is higher than the saturated water vapor pressure in the condenser 40 so as to correspond to the water column pressure of 840 mm, it is difficult to seal this only by the height of the refrigerant pool in the condenser 40, and yet the check valve 61 is capable of preventing the liquid refrigerant from flowing back from the evaporator 30 to the condenser 40 through the liquid refrigerant flow path 60.

It should be noted that the temperature-sensitive valve 51a and the temperature-sensitive valve 51b are provided in the present embodiment, the temperature-sensitive valve 51a is open when the temperature on the one surface side is equal to or higher than a predetermined temperature and is closed when the temperature is lower than the predetermined temperature, the temperature-sensitive valve 51b is closed when the temperature on the other surface side of the structure 1 is equal to or higher than a predetermined temperature and is open when the temperature is lower than the predetermined temperature, and yet the present invention is not limited thereto. The temperature-sensitive valves 51a and 51b may be manual valves or may have temperature hysteresis. In addition, the refrigerant may lose the fluidity thereof as a result of, for example, solidification or gelation at a temperature lower than a predetermined temperature.

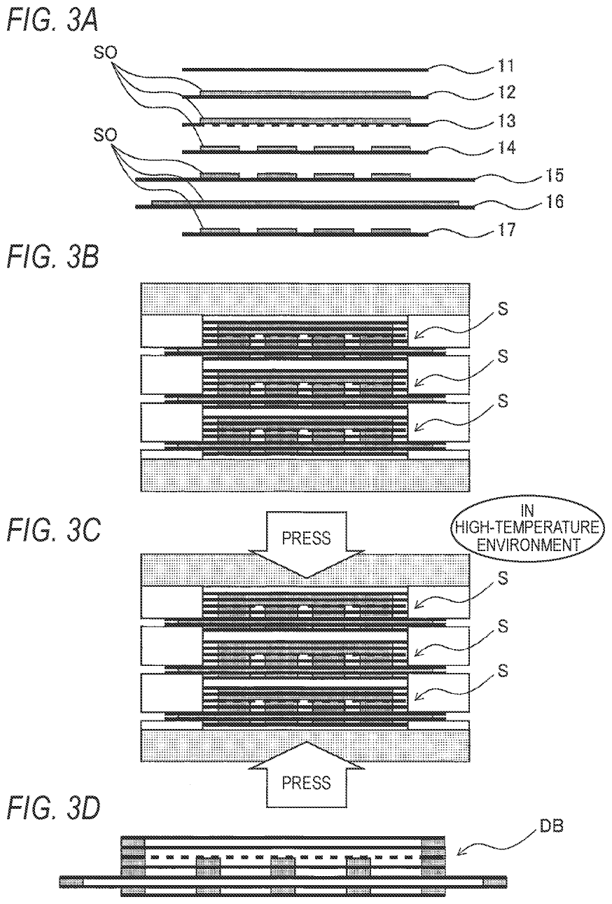

Next, a method for manufacturing the structure 1 according to the present embodiment will be described. FIGS. 3A to 6B are process diagrams illustrating the method for manufacturing the structure 1 according to the present embodiment. First, as illustrated in FIG. 3A, the first plate material 11 to the seventh plate material 17 cut to a predetermined size are stacked and a stacked body S (see FIG. 3B) is obtained. As for this stacking, a stop-off material SO is pre-applied to parts not subject to joining.

Next, as illustrated in FIG. 3B, a ceramic sheet is interposed between a plurality of the stacked bodies S and the plurality of stacked bodies S are stacked. After the stacking, the plurality of stacked bodies S are put into a vacuum furnace and pressed in a high-temperature environment of, for example, 1000° C. as illustrated in FIG. 3C. At this time, the first plate material 11 to the seventh plate material 17 are diffusion-joined at the parts where the stop-off material SO (see FIG. 3A) is not applied (joining step).

As a result, a diffusion-joined body DB in which predetermined parts are diffusion-joined is manufactured as illustrated in FIG. 3D.

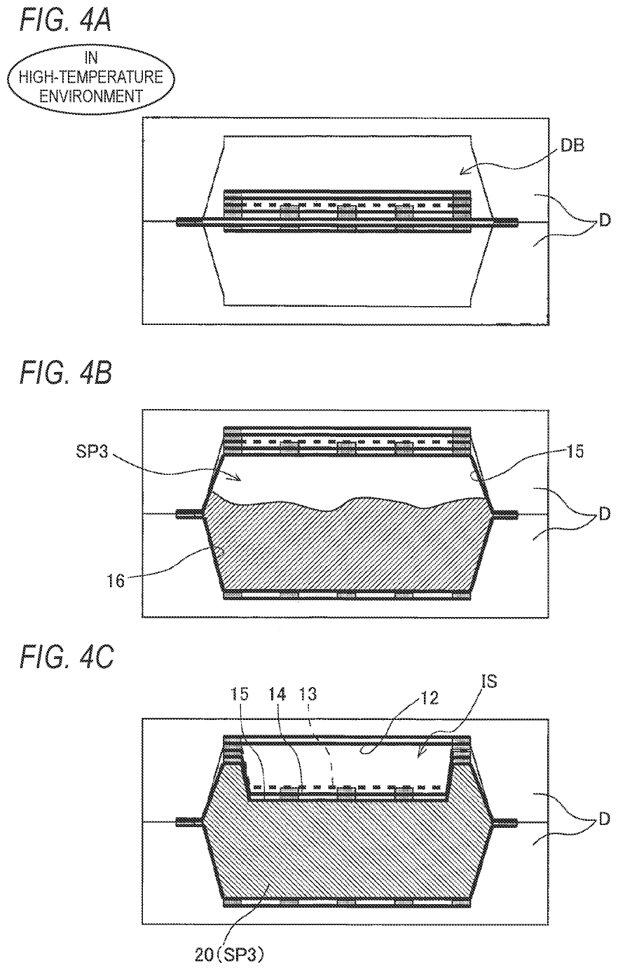

Next, as illustrated in FIG. 4A, the diffusion-joined body DB is put into a mold D having a predetermined shape. The inside of the mold D itself has airtightness and a heater function or is heated in a state where the inside of the mold D can be vacuumized by installation in the vacuum furnace. For example, the inside of the mold D is in a high-temperature environment of 900° C. (800° C. or higher).

Subsequently, as illustrated in FIG. 4B, pressurization with a gas such as argon is performed between the fifth plate material 15 and the sixth plate material 16. The third space portion SP3 is formed as a result. Next, the inside of the mold D is vacuumized, the inside of the third space portion SP3 is also depressurized, and pearlite powder is drawn thereinto.

Next, as illustrated in FIG. 4C, pressurization with a gas such as argon is performed between the second plate material 12 and the fourth plate material 14 (or between the second plate material 12 and the third plate material 13). As a result, the third to fifth plate materials 13 to 15 protrude to the other surface side and the pearlite powder in the third space portion SP3 is pressed to result in diffusion joining. The heat insulating layer 20 is formed as a result. Further, by the third to fifth plate materials 13 to 15 protruding to the other surface side, an introduction space IS for introducing pearlite powder for forming the wick layer 31 (see the drawings including FIG. 1) in a later step is formed.

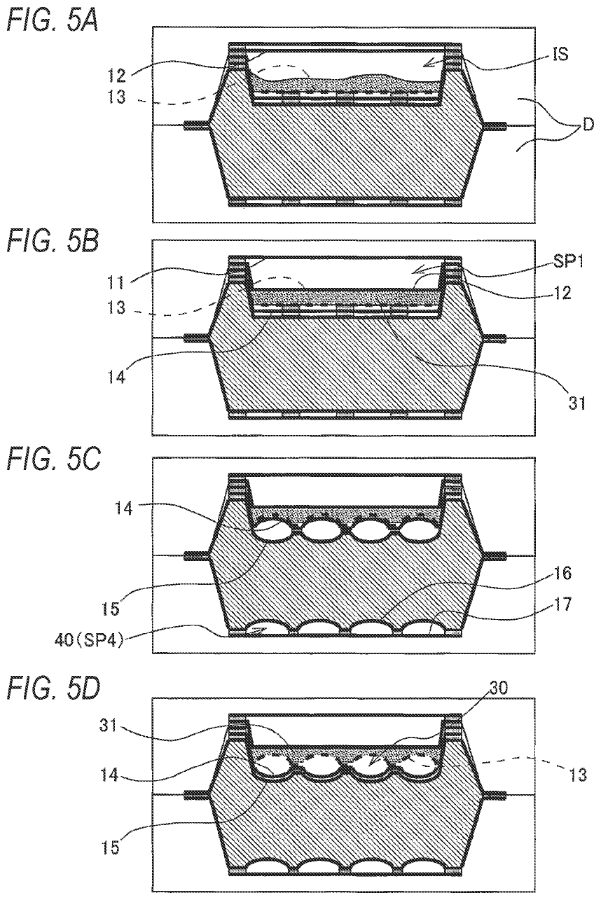

Next, as illustrated in FIG. 5A, the introduction space IS (between the second plate material 12 and the third plate material 13) is also depressurized and pearlite powder is drawn thereinto with the inside of the mold D kept in a vacuum (powder introduction step). Subsequently, as illustrated in FIG. 5B, pressurization with a gas such as argon is performed between the first plate material 11 and the second plate material 12. As a result, the first space portion SP1 is formed and the pearlite powder between the second plate material 12 and the third plate material 13 is pressed and diffused-joined (solidified) to form the wick layer 31 (solidification step). Here, although the third plate material 13 has an opening portion and the pearlite powder is to pass through the opening portion, the pearlite powder can be stopped by the fourth plate material 14 after entering the opening portion since the fourth plate material 14 is positioned adjacent to the third plate material 13.

It should be noted that the wick layer 31 is formed by baking while the high-temperature environment at the time when the introduction space IS is formed is maintained (that is, the wick layer 31 is formed as a sintered body) and yet the present invention is not limited thereto. The wick layer 31 may be formed by a solidified body using a change in phase or a change in fluidity. In this case, the wick layer 31 can be configured by, for example, a mixture of pearlite and a fusion material such as powdered glass fluidizing at approximately 800° C. In this case, introduction in a high-temperature environment results in a viscous substance by the powdered glass of the mixture fluidizing, which functions as a binder binding pearlite grains.

Next, as illustrated in FIG. 5C, pressurization with a gas such as argon is performed between the fourth plate material 14 and the fifth plate material 15 and between the sixth plate material 16 and the seventh plate material 17. In particular, the condenser 40 (fourth space portion SP4) is formed as a result of the latter pressurization.

Subsequently, as illustrated in FIG. 5D, pressurization with a gas such as argon is performed between the third plate material 13 and the fourth plate material 14. As a result, the fourth plate material 14 adjacent to the third plate material 13 side moves to the fifth plate material 15 side. The evaporator 30 having the wick layer 31 is formed as a result.

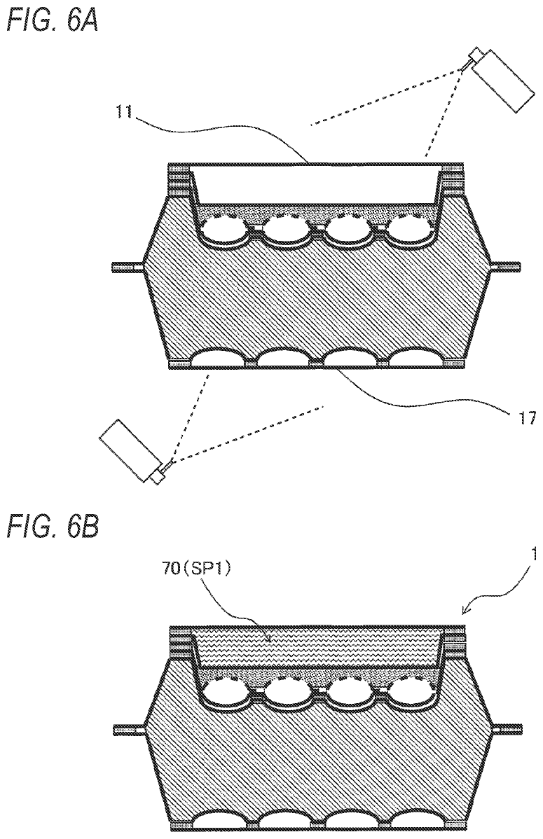

Next, as illustrated in FIG. 6A, the above is taken out of the mold D (see the drawings including FIG. 5D) and at least a part of the outer surfaces of the first plate material 11 and the seventh plate material 17 in a high-temperature state (approximately 900° C.) is sprayed with enameling glaze powder (for example, surface treatment material fusing at a melting temperature of 850° C. or higher). After the spraying, the glaze is fused to the outer surfaces of the plate materials 11 and 17 and then cooled to form a strong heat-resistant coating film (enamel). In a case where the wick layer 31 is configured by pearlite and powdered glass, the pearlite grain-bound glass is solidified as it is by cooling and the entire wick layer 31 is solidified as a result. The enameling, in particular is performed with the first plate material 11 and the seventh plate material 17 in a high-temperature state (approximately 900° C.). Accordingly, the labor of reheating the whole structure 1 in a furnace after performing spraying or the like on the cooled structure 1 is omitted.

Subsequently, the latent heat storage material 70 is introduced into the first space portion SP1 as illustrated in FIG. 6B.

As for the structure 1 according to the present embodiment described above, the evaporator 30 has the wick layer 31 for evaporating the refrigerant stored on the lower portion side with heat from the one surface side of the evaporator 30 while suctioning up the refrigerant by capillarity and holding the refrigerant. Accordingly, the wick layer 31 is capable of extending the evaporation part in the suction direction and a larger area can be covered with a smaller number of stages. In addition, since the evaporator 30 and the condenser 40 are installed so as to overlap by ½ or more in the refrigerant suction direction of the wick layer 31, the amount of suction-direction misalignment between the evaporator 30 and the condenser 40 decreases and a dead space is unlikely to arise. Accordingly, a decrease in the number of stages and a decrease in dead space can be achieved.

In addition, by having the vapor flow path 50, the temperature-sensitive valves 51a and 51b, the liquid refrigerant flow path 60, and the check valve 61, it is possible to switch between a heat insulation state (for example, winter and summer daytime) and a heat dissipation state (for example, summer night) or between a heat insulation state (for example, summer and winter night) and a heat collection state (for example, winter daytime). Although it is necessary to be capable of responding to significant refrigerant liquid surface fluctuations in order to realize a heat insulation state, the necessity can be responded to by increasing the heights of the evaporator 30 and the condenser 40 with the wick layer 31. In addition, since the number of stages is small, the temperature-sensitive valves 51a and 51b and the check valve 61 to be installed can be reduced in number.

In addition, the wick layer 31 is configured by a solidified body or a sintered body made of pearlite powder non-uniform in particle size in a particle size range of 150 micrometers or less. Here, the present inventor has found that the suction effect is enhanced by the wick layer 31 having different particle sizes equal to or less a predetermined value (150 micrometers). As a result, it is possible to provide the wick layer capable of suctioning up a refrigerant (for example, water) up to a height of, for example, 2 m, more preferably, approximately 0.2 m or more and 1.0 m or less and holding the refrigerant.

In addition, the latent heat storage material 70 is further provided on the one surface side of the evaporator 30. Accordingly, in a case where the one surface side is an indoor side, for example, the indoor temperature environment is maintained by the latent heat storage material 70 even with the temperature on the other surface side (for example, outdoor side) high and the heat of the latent heat storage material 70 can be transferred to the other surface side at a timing when the temperature on the other surface side has become low.

In addition, the wick layer 31 has a heat resistance of 850° C. or higher. Accordingly, the structure 1 highly resistant to heat as a whole can be provided by constructing the structure 1 by combining, for example, the heat insulating layer 20 having a heat resistance of 850° C. or higher and used as a building material or the like.

Further, according to the method for manufacturing the structure 1 according to the present embodiment, the wick powder introduction space IS is formed by performing pressurization between the second plate material 12 and the fourth plate material 14 in a high-temperature environment of 800° C. or higher, the wick powder is introduced into the formed introduction space IS, and the introduced wick powder is solidified with the high-temperature environment maintained. Accordingly, the wick powder can be solidified and the wick layer 31 can be formed without any change in the high-temperature environment in which the second plate material 12 and the fourth plate material 14 are processed and a contribution can be made to the smooth manufacturing of the structure 1.

Next, a second embodiment of the present invention will be described. The structure 1 according to the second embodiment is similar to the structure 1 according to the first embodiment and both are partially different from each other in configuration. Hereinafter, the differences from the first embodiment will be described.

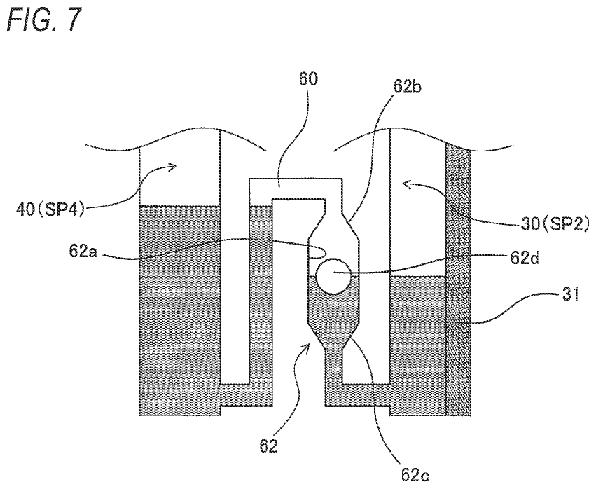

FIG. 7 is a schematic configuration diagram illustrating the lower portion side of the structure 1 according to the second embodiment. In the second embodiment, a float valve 62 instead of the check valve 61 is used on the liquid refrigerant flow path 60. The other configurations of the second embodiment are identical to those of the first embodiment. The float valve 62 has a cylindrical float chamber 62a installed in the vertical direction. An upper end 62b of the float valve 62 is squeezed in a reverse funnel shape and connected to the condenser 40. A lower end 62c of the float valve 62 is squeezed in a funnel shape and connected to the evaporator 30. A float 62d in the float chamber 62a is capable of blocking the refrigerant flow path 60 when pressed against either the funnel at the lower end or the reverse funnel at the upper end. Accordingly, the float valve 62 opens the refrigerant flow path 60 only when a refrigerant liquid surface is within the range of the height of the float chamber 62a.

During normal heat pipe operation (during heat transmission operation from the evaporator 30 side to the condenser 40 side) such as nighttime heat pipe operation in summer, the refrigerant liquid surface height in the float valve 62 is the same as the refrigerant liquid surface height in the evaporator 30. Accordingly, the float 62d temporarily descends and the liquid refrigerant is allowed to flow into the float valve 62 from the condenser 40 in the event of a decrease in the height of the refrigerant in the evaporator 30 and the liquid refrigerant is allowed to flow into the evaporator 30 from the inside of the float valve 62 when the float 62d floats away from the funnel. Even in a case where the refrigerant in the condenser 40 has vaporized and the vapor refrigerant pressure has risen by day in summer, the refrigerant liquid surface in the evaporator 30 remains lower than the height of the reverse funnel of the float valve 62. As a result, there is no need for the refrigerant liquid surface height in the evaporator 30 to be 355 mm or more as described above.

Even in a case where the evaporator 30 is higher in pressure than the condenser 40, examples of which include winter, the float 62d ascends and is pressed against the reverse funnel to result in blocking when a small amount of liquid refrigerant flows into the float valve 62 from the evaporator 30. As a result, an effect similar to that of the check valve 61 described in the first embodiment can be exhibited.

Although the float 62d is floated in the float valve 62 in the second embodiment, the valve provided in the liquid refrigerant flow path 60 may be opened and closed via an arm with the float 62d floated in the evaporator 30 by a structure similar to a float valve used in the water tank of a flush toilet or the like.

In this manner, effects similar to those of the first embodiment can be exhibited with the structure 1 according to the second embodiment.

Although the present invention has been described above based on the embodiments, the present invention is not limited to the above embodiments. Changes may be made without departing from the spirit of the present invention, and publicly known or well-known techniques may be appropriately combined to a possible extent.

For example, although it is assumed that the seven plate materials 11 to 17 in the present embodiments are configured by metal plates, the present invention is not limited thereto. If possible, the seven plate materials 11 to 17 may be configured by another material such as resin. Further, although the structure 1 has the seven plate materials 11 to 17, the number is not particularly limited to seven and may be, for example, four. In this case, the heat insulating layer 20, the evaporator 30, and the condenser 40 may be provided with the second to fourth space portions SP2 to SP4 formed in the structure 1. In addition, the structure 1 according to the present embodiments may be used for another building material such as a roofing material and a window without being limited to the wall material. In addition, the structure 1 according to the present embodiments may be used for, for example, a box material requiring internal cooling without being limited to the building material.

In addition, the powder forming the wick layer 31 is slurry in which powder is dissolved in a solvent in the event of introduction and the solvent may be vaporized in a high-temperature environment.

An example in which the powder forming the wick layer 31 is introduced in the powder introduction step illustrated in FIG. 5A has been illustrated. In another example, the powder may be applied between the plate material 12 and the plate material 13, for example, to the lower surface of the plate material 12 (powder placement step) in the step of applying the stop-off material SO illustrated in FIG. 3A and the powder may be solidified in the joining step of FIG. 3C (joining and solidification step). In that case, alumina powder highly resistant to heat and functioning as the stop-off material SO or the like and pearlite powder likely to be solidified in the joining step of FIG. 3C may be mixed or stacked. As a result, the formation of the space IS and the powder introduction step illustrated in FIG. 5A can be omitted and the solidified wick layer 31 at the point in time of FIG. 5C is softened by the high temperature and is capable of allowing deformation of the plate material 14. Further, the material of the wick layer is not limited to powder and carbon fibers and so on may be used. In that case, solidification may be performed in the joining step of FIG. 3C after pearlite powder is stacked on the carbon fibers arranged on the plate material 13 in the step of applying the stop-off material SO illustrated in FIG. 3A.

Although various embodiments have been described above with reference to the drawings, it is a matter of course that the present invention is not limited to such examples. It is clear that those skilled in the art can come up with various examples of change or modification within the scope of the claims, which naturally and understandably belong to the technical scope of the present invention. In addition, the above components of the embodiments may be combined in any manner without departing from the spirit of the present invention.

According to the present invention, it is possible to provide a structure and a method for manufacturing the structure with which a decrease in the number of stages and a decrease in dead space can be achieved.

1. A structure comprising:
a heat insulating layer;
an evaporator formed using a space portion between a plurality of plate materials provided on one surface side of the heat insulating layer;
a condenser formed using a space portion between a plurality of other plate materials provided on the other surface side of the heat insulating layer;
a vapor flow path for guiding refrigerant vapor generated as a result of evaporation at the evaporator to the condenser; and
a liquid refrigerant flow path for guiding a liquid refrigerant generated as a result of condensation at the condenser to the evaporator, wherein
the evaporator has a wick layer for evaporating the refrigerant stored on a lower portion side with heat from one surface side of the evaporator while suctioning up the refrigerant by capillarity and holding the refrigerant, and
the evaporator and the condenser are installed so as to overlap by ½ or more in the direction in which the wick layer suctions up the refrigerant.

2. The structure according to claim 1, further comprising blocking means for blocking at least one of the vapor flow path and the liquid refrigerant flow path.

3. The structure according to claim 1, wherein the wick layer is formed by solidifying powder non-uniform in particle size in a particle size range of 150 micrometers or less.

4. The structure according to claim 1, further comprising a latent heat storage material on the one surface side of the evaporator.

5. The structure according to claim 1, wherein the wick layer has a heat resistance of 850° C. or higher.

6. A structure manufacturing method comprising:
a joining step of partially joining four or more plate materials;
a space forming step of forming a wick powder introduction space by performing pressurization in a high-temperature environment of 800° C. or higher between the four or more plate materials partially joined in the joining step;
a powder introduction step of introducing wick layer forming powder into the introduction space formed in the space forming step; and
a solidification step of solidifying the powder introduced in the powder introduction step in a state where the high-temperature environment is maintained.

7. A structure manufacturing method comprising:
a powder placement step of placing wick layer forming powder in at least one place between four or more plate materials; and
a joining and solidification step of partially joining the four or more plate materials by pressurization in a high-temperature environment of 800° C. or higher and solidifying the powder placed in the powder placement step by the high-temperature environment and pressurization.
